(19) United States
(12) Patent Application Publication
(10) Pub. No.: US 2013/0346152 A1
(43) Pub. Date: Dec. 26, 2013

(54) DETERMINING CUSTOMER GROUPS FOR CONTROLLED PROVISION OF OFFERS

(71) Applicants: Shafi Rahman, Malsch (DE); Bare Said, St. Leon (DE)

(72) Inventors: Shafi Rahman, Malsch (DE); Bare Said, St. Leon (DE)

(21) Appl. No.: 13/531,429

(22) Filed: Jun. 22, 2012

(51) Int. Cl. G06Q 30/02

(52) U.S. Cl. 705/7.31

(57) ABSTRACT

A controlled and optimal provision of offers to customers on associated products is described. A three dimensional matrix characterizes product, customer, and time dimensions. Each product is associated with volume constraint(s). The three dimensional matrix is populated with scores. A score characterizes likelihood of a customer to purchase a corresponding product in an associated time period. First pairs of products and customers are randomly selected. The scores associated with the first pairs are changed to zero. Using volume constraints, an optimization is performed that excludes customers of the first pairs from a provision of best offers so that those customers are provided alternate offers. Based on the volume constraints, second pairs of products and customers are selected. The scores associated with the second pairs of products and customers are changed to one. Using volume constraints, optimization is performed such that customers of the second pairs are always provided best offers.

### TECHNICAL FIELD

The subject matter described herein relates to determining groups of customers for controlled provision of relevant offers on associated products in real time.

### BACKGROUND

Merchants can have a large number of customers. Sometimes, these merchants can have funding (for example, funding resulting from margins provided by manufactures of products sold by the retailers) so as to provide one or more discount offers to their customers on one or more products. Conventionally, the retailers provide a similar discount offer to all customers. Providing a similar discount offer to all customers can be disadvantageous, as it does not account for effectiveness of provision of discount offers to customers. In other conventional implementations, different discount offers are provided in a random order to a customer, as randomly determined by the retailer. Such a random provision may not be effective.

### SUMMARY

The current subject matter relates to a controlled and optimal real-time provision of offers to customers on associated products and/or services. A three dimensional matrix can characterize product, customer, and time dimensions. Each product can be associated with corresponding one or more volume constraints. The three dimensional matrix can be populated with scores. A score can characterize a likelihood of a customer to purchase a corresponding product in an associated time period. First pairs of products and customers can be randomly selected. The scores associated with the first pairs can be changed to zero. Using the volume constraints, optimization can be performed that can exclude customers of the first pairs from a provision of best (that is, most-optimal or most-relevant or most-effective) offers so that those customers can be provided alternate offers, thereby creating a random holdout group of customers for each product. Based on the volume constraints, second pairs of products and customers can be selected. The scores associated with the second pairs of products and customers can be changed to one. Using the volume constraints, optimization can be performed such that customers of the second pairs can be always/often provided offers on the products, thereby creating a random mass mailing group of customers for each product.

In one aspect, a three dimensional matrix can be populated with a first plurality of scores. Each score can characterize a likelihood of a corresponding customer to purchase a respective product in an associated period of time. From a second plurality of scores associated with a spatial intersection of the three dimensional matrix at a particular period of time, a first set of one or more scores of the second plurality of scores can be randomly determined. The randomly determined first set of one or more scores can be changed to zero. One or more offers can be provided to corresponding one or more customers when associated one or more scores are more than zero.

In some variations, historical purchase data associated with a plurality of customers and a plurality of products can be obtained. The first plurality of scores can be generated by using the historical purchase data. The historical purchase data can include one or more products that are purchased, one or more unique identifiers for respective one or more customers purchasing the one or more products, and one or more timestamps associated with corresponding purchases of the one or more products. The historical purchase data can further include one or more product web-pages that are viewed, one or more unique identifiers for respective one or more customers viewing the one or more products web-pages, and one or more timestamps associated with corresponding views of the one or more web-pages.

The three dimensional matrix can include the first plurality of scores placed according to a customer dimension, a product dimension, and a time dimension.

The particular period of time can be provided by a merchant. The merchant can sell the plurality of products to the plurality of customers.

The spatial intersection of the three dimensional matrix at the particular period of time can characterize a two dimensional matrix that includes the second plurality of scores placed according to a customer dimension and a product dimension.

The random determining of the first set of one or more scores can be performed by using a first pseudorandom number generation algorithm. The first pseudorandom number generation algorithm can be performed by a linear congruential generator.

Further, based on the second plurality of scores and the changed scores, a provision of offers can be optimized for the plurality of products to the plurality of customers. The portion of the randomly determined first set of one or more scores (for customer-product pairs) that are changed to zero can be excluded from the optimizing. Based on the optimizing, alternative one or more offers for one or more products can be provided to corresponding one or more customers when associated one or more propensity scores are zero. The three dimensional matrix can further include one or more volumetric constraints associated with one or more products. The one or more volumetric constraints can be provided by a merchant. Each volumetric constraint can limit a number of offers that can be provided for an associated product. The optimizing can be performed by an optimization engine. The volumetric constraints can be input to the optimization engine so as to determine the offers for the plurality of products to the plurality of customers.

For a corresponding product and based on a volumetric constraint specific for each product, a number of customers can be calculated. For the corresponding product and for the calculated number of times, a customer can be randomly selected. A number of times a propensity score associated with the corresponding product and the randomly selected customer is previously reassigned can be one of less than and equal to a threshold. The propensity score associated with the corresponding product and the customer can be changed to one. An offer for the corresponding product can be provided to the randomly selected customer. The calculating of the number of customers for the corresponding product is based on: x={f*n*(vᵢ/vₜₒₜₐₗ)}, wherein: x can be the number of customers for the corresponding product, f can be the a number of expected reassignments per customer, n can be a number of customers in the spatial intersection of the three dimensional matrix, vᵢ can be a volumetric constraint on an i^{th} product, and vₜₒₜₐₗ can be a sum of vᵢ over products associated with the first plurality of scores. The random selecting can be performed by using a pseudorandom number generation algorithm. The pseudorandom number generation algorithm can be performed by a linear congruential generator. The pseudorandom number generation algorithm can be same as a first pseudorandom number generation algorithm used to randomly determine the first set of one or more scores. The volumetric constraint can be provided by a merchant. The threshold can be a ceiling value of a particular percentage of a number of products in the spatial intersection of the three dimensional matrix. The providing of the offer to the randomly selected customer can occur in real time.

The providing of one or more offers to corresponding one or more customers when associated one or more scores are more than zero can include excluding other customers from being provided offers when associated score is zero. The populating of the three dimensional matrix, the changing of the randomly determined first set of one or more scores to zero, and the excluding the providing of offers to the other customers can occur in real time.

In another aspect, a two dimensional matrix characterizing a product/service dimension and a customer dimension can be obtained. The two dimensional matrix can be populated with a plurality of propensity scores. Each propensity score can characterize a likelihood of a corresponding customer to purchase a respective product/service. One or more positions of propensity scores in the two dimensional matrix can be randomly determined. Propensity scores associated with the randomly determined positions can be changed to zero. One or more offers can be provided to corresponding one or more customers when associated one or more propensity scores are more than zero.

In some variations, the two dimensional matrix can be obtained using a time-to-event model.

A provision of offers for the plurality of products/services to the plurality of customers can be optimized. The randomly determined first set of one or more scores that can be changed to zero can be excluded from the optimizing.

In yet another aspect, a two dimensional matrix including a plurality of products/services and a plurality of customers can be obtained. The two dimensional matrix can be populated with a plurality of propensity scores. For a corresponding product/service and based on a volumetric constraint specific for each product/service, a number of customers can be calculated. For the corresponding product/service and for the calculated number of times, a customer can be randomly selected. A number of times a propensity score associated with the corresponding product/service and the randomly selected customer is previously reassigned can be one of less than and equal to a threshold. The propensity score associated with the corresponding product/service and the customer can be changed to one. An offer for the corresponding product/service can be provided to the randomly selected customer.

The number of customers for the corresponding product/service is calculated based on: x={f*n*(vᵢ/vₜₒₜₐₗ)}, wherein: x can be the number of customers for the corresponding product/service, f can be the a desired number of expected reassignments per customer, n can be a number of customers in the two dimensional matrix, vᵢ can be a volumetric constraint on an i^{th} product/service, and vₜₒₜₐₗ can be a sum of vᵢ over products/services in the two dimensional matrix.

Each propensity score can characterize a likelihood of a corresponding customer to purchase a respective product/service.

Articles of manufacture are also described that comprise computer executable instructions permanently stored on computer readable media, which, when executed by a computer, causes the computer to perform operations herein. Similarly, computer systems are also described that may include a processor and a memory coupled to the processor. The memory may temporarily or permanently store one or more programs that cause the processor to perform one or more of the operations described herein.

The subject matter described herein provides many advantages. For example, the subject matter can allow a real-time determining of customers who may not be provided an offer on respective product so as to form/create one or more random holdout groups, and real time determining of customers who can be provided (for example, often provided or always provided) offer on a respective product so as to form/create one or more random mass mailing groups. This can be advantageous over systems that perform such an analysis of determining offers significant time prior to providing the offers rather than in real time. As variables and features associated with past purchase behavior of customers can keep changing on a real time basis, real-time determining of customers that can be provided an offer can be advantageous. The implemented methodology can account for a continuous change of purchase behavior. Further, the implemented methodology can ensure that each customer assigned in a control group for a product can still receive relevant offers on other available products, as opposed to conventional (for example, non-real time) approaches where such customers may always end up getting either no offer (for example, in case of conventional random holdout group) or completely random offers (for example, in case of conventional random mass mailing groups).

Further, the exclusion of some customers from provision of offers can allow a higher availability of offers for other customers. Such a higher availability can provide a more effective optimization for those other customers. This more effective optimization can increase relevance of those offers to those other customers so that a likelihood of a use of the provided offers by those other customers is increased. Such an increased likelihood of use of offers can cause an increase in sales, profit, and loyalty associated with the products for which offers are provided to those other customers.

Furthermore, the subject matter can allow an automatic determining of best (for example, most-optimal or most-relevant or most-effective) offers in real time, which can be more efficient that a manual determining of best offers.

Moreover, the current subject matter implements simple algorithms that can use computing resources (for example, processor speed, storage space, and the like) that can be significantly less than resources used by conventional methods of determining offers. Thus, there can be a low cost of implementation, as minimal coding can be used for these algorithms.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating aspects of a method consistent with implementations of the current subject matter;

FIG. 2 is a process flow diagram illustrating changing of a portion of the randomly determined first set of one or more scores to zero;

FIG. 3 is a process flow diagram illustrating changing of a portion of the randomly determined second set of one or more scores to one;

FIG. 4 illustrates an example of a three dimensional matrix;

FIG. 5 illustrates a spatial intersection of the three dimensional matrix at a particular period of time along the time dimension;

FIG. 6 illustrates a spatial intersection showing, in enclosed rectangular boxes, scores corresponding to the randomly determined pairs of customers and products;

FIG. 7 illustrates a spatial intersection with some scores changed to zero;

FIG. 8 illustrates a spatial intersection where box-enclosed positions characterize some results of optimization;

FIG. 9 is a process flow diagram illustrating aspects of a method consistent with implementations of the current subject matter; and

FIG. 10 is a process flow diagram illustrating aspects of a method consistent with implementations of the current subject matter.

Like reference symbols in the various drawings indicate like elements.

### DETAILED DESCRIPTION

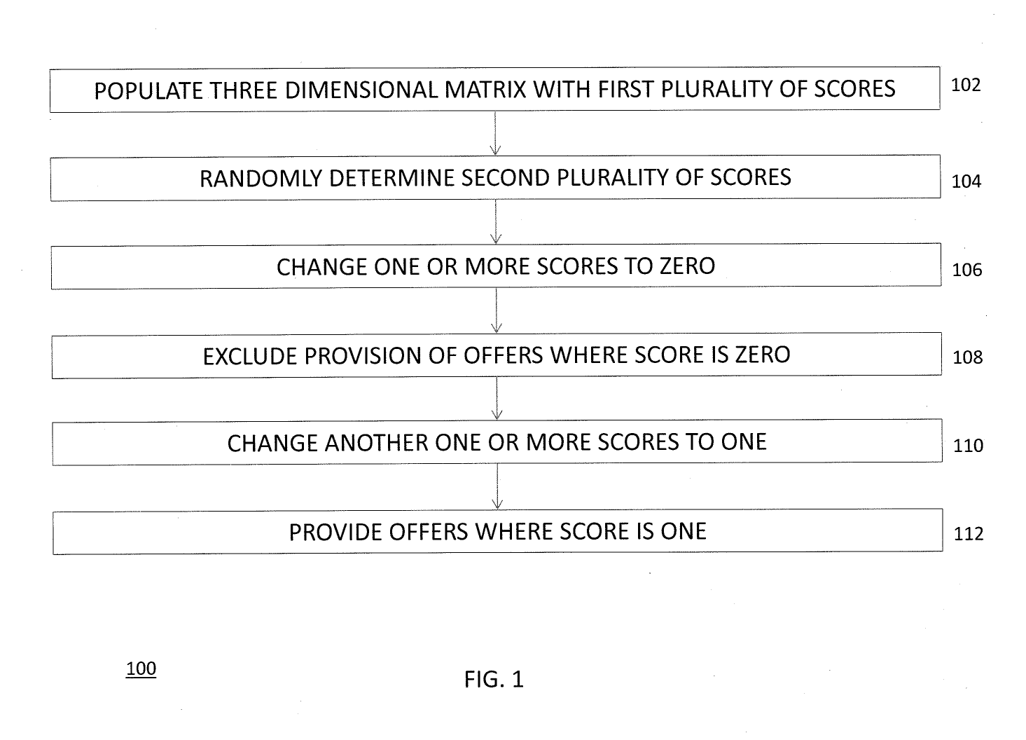

FIG. 1 is a process flow diagram 100 illustrating aspects of a method consistent with implementations of the current subject matter. A three dimensional matrix can be populated, at 102, with a first plurality of scores. A score (for example, each score of the plurality of scores) can characterize a likelihood of a corresponding customer to purchase a respective product in an associated period of time. A second plurality of scores can be associated with a spatial intersection of the three dimensional matrix at a particular period of time. From the second plurality of scores, a first set of one or more scores can be randomly determined at 104. A portion of the randomly determined first set of one or more scores can be changed to zero (“0”) at 106. When a score associated with a product and a customer is zero, the customer can be excluded, at 108, from provision of an offer (in some implementations, excluded from provision of a best offer) on the product. However, the customer can still be provided offers on the other products. An offer can be a discount offer, a gift, a present, a proposal, a giving, or the like. From the second plurality of scores, a second set of one or more scores can be randomly determined at 110. A portion of the randomly determined second set of one or more scores can be changed to one (“1”) at 112. When a score associated with a product and a customer is one, the customer can be provided an offer (in some implementation, provided the best offer).

Although features of 102, 104, 106, 108, 110, and 112 have been described, some implementations can implement only some of those features. That is, some implementations implement features of only 102, 104, 106, and 108, while features of 110 and 112 can be optional. Other implementations implement features of 102, 104, 110, and 112, while features of 106 and 108 can be optional.

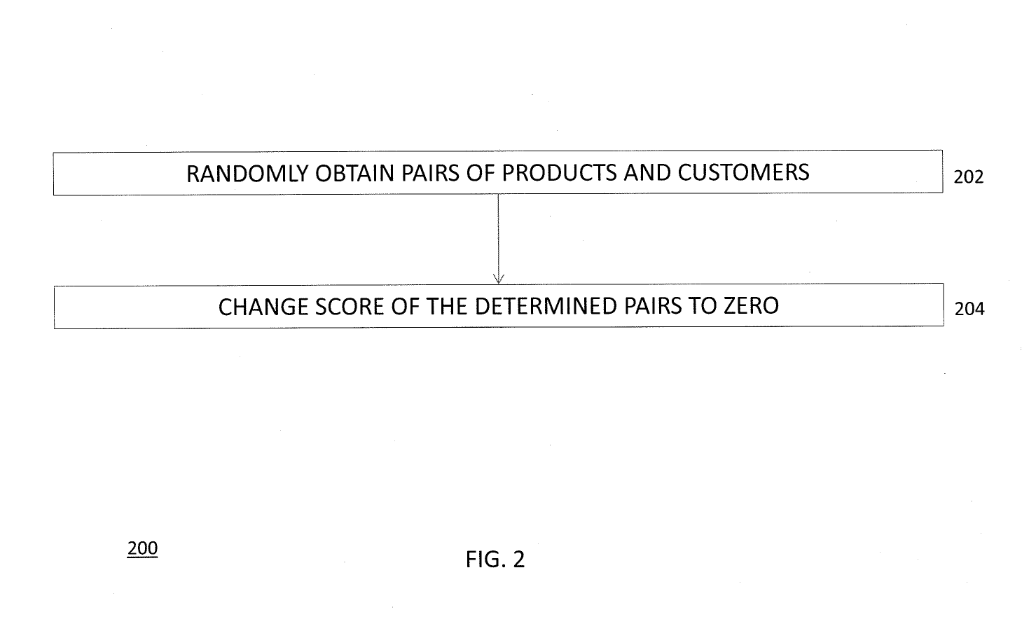

FIG. 2 is a process flow diagram 200 illustrating changing the randomly determined first set of one or more scores to zero. Pairs of products and customers can be randomly obtained at 202 such that the randomly obtained pairs can be located on a spatial intersection of the three dimensional matrix. Scores associated with these randomly determined pairs can be changed to zero at 204.

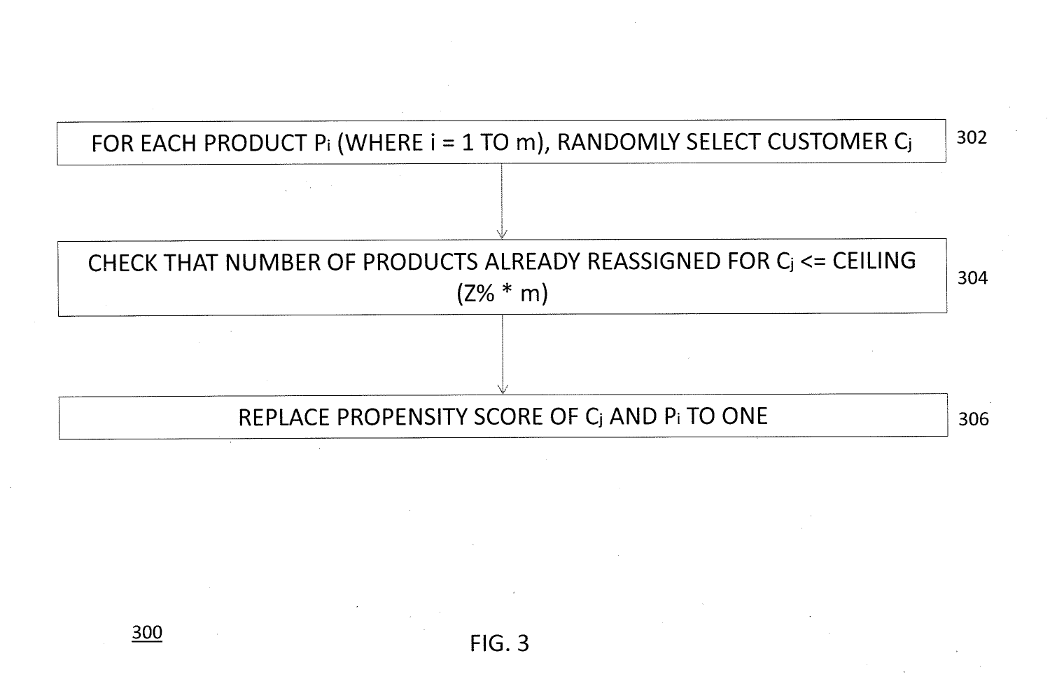

FIG. 3 is a process flow diagram 300 illustrating changing of a portion of the randomly determined second set of one or more scores to one. For each product Pᵢ (i=1 to m, where m is total number of products in either the three dimensional matrix or the spatial intersection), a customer Cⱼ can be randomly selected at 302. It can be checked, at 304, that a number of products already reassigned for Cⱼ can be <=ceiling (z %*m). The value of z % can be provided by a merchant. Propensity score of Cⱼ and Pᵢ can be changed to one at 306. Subject matter of 302, 304, and 306 can be implemented for x randomly selected customers for each product, where x can be calculated according to the equation/formula: [x={f*n*(vᵢ/vₜₒₜₐₗ)}], wherein: x can be the number of customers for the corresponding product, f can be the a desired number of expected reassignments per customer, n can be a total number of customers in the spatial intersection of the three dimensional matrix, vᵢ can be a volumetric constraint on an i^{th} product, and vₜₒₜₐₗ can be a sum of vᵢ over products in the spatial intersection.

Although the formula [x={f*n*(vᵢ/vₜₒₜₐₗ)}] has been described herein, other formulas can also be used such that those other formulas provide results similar to those provided by the above-referred formula.

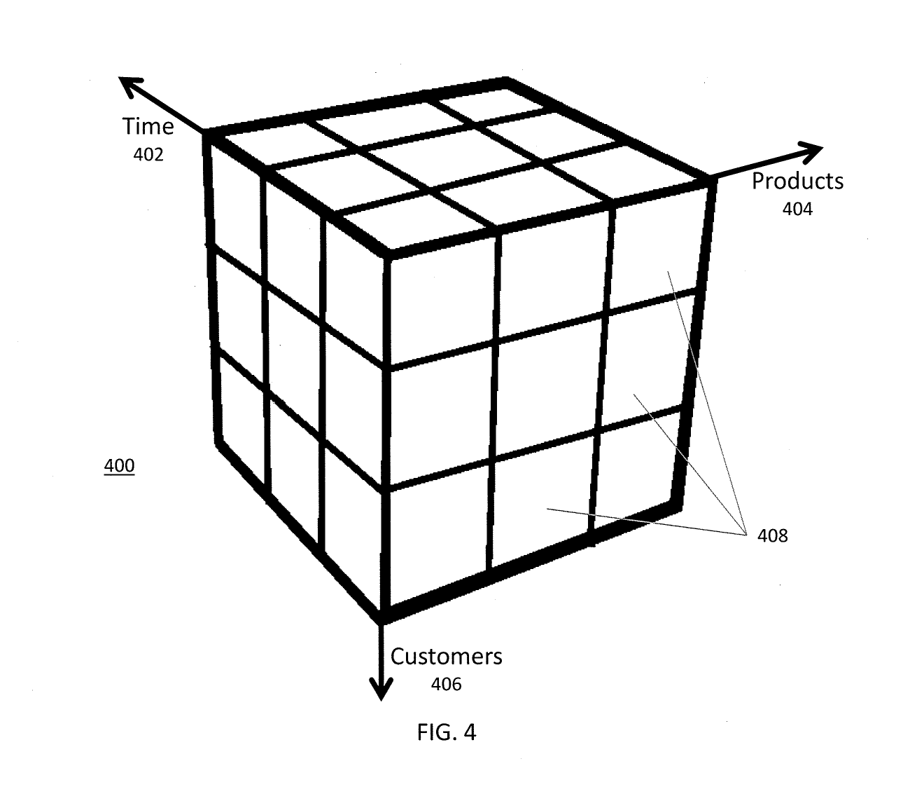

FIG. 4 illustrates an example of a three dimensional matrix 400. The three dimensional matrix 400 can have a time dimension 402, a product dimension 404, and a customer dimension 406. The three dimensional matrix 400 can be formed of three dimensional boxes 408. Each box 408 can be populated with a respective score. A score can characterize a likelihood of a corresponding customer to purchase a respective product in an associated period of time. Each product can be associated with a corresponding volume constraint. The volume constraints can be provided by a merchant. An example of a volume constraint for a particular product can be a quantity of the particular product that can be sold by the merchant, wherein the quantity can be based on inventory of the particular product available with the merchant. Another example of volume constraint can be a suggested maximum number of offers that should be provided to a single customer, wherein the suggestion can be made by the merchant, product experts, product manufacturers, or the like.

Although use of volume constraints is described herein, volume constraints may not be necessary for implementing the described aspects. That is, the implementations (for example, implementations associated with optimization described herein) can be implemented even when there are no volume constraints, or when the volume constraints are unavailable or absent.

The scores populated in the three dimensional matrix 400 can be generated using historical purchase data associated with a plurality of customers and a plurality of products. The historical purchase data can include one or more of the following, individually or in combination: one or more products that are purchased, one or more unique identifiers for respective one or more customers purchasing the one or more products, and one or more timestamps associated with corresponding purchases of the one or more products. Further, the historical purchase data can include one or more of the following, individually or in combination: one or more product web-pages that are viewed, one or more unique identifiers for respective one or more customers viewing the one or more products web-pages, and one or more timestamps associated with corresponding views of the one or more web-pages.

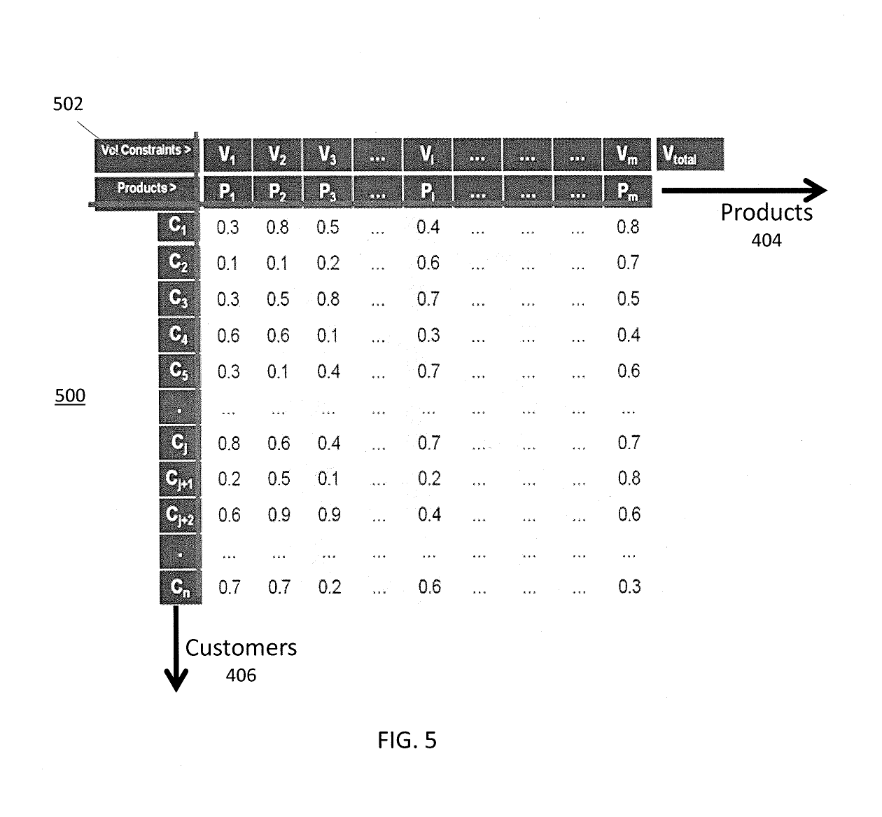

FIG. 5 illustrates a spatial intersection 500 of the three dimensional matrix 400 at a particular period of time along the time dimension 402. The spatial intersection 500 can characterize a two dimensional matrix 500 that can have a product dimension 404 and a customer dimension 406. The spatial intersection 500 can correspond to a second plurality of scores out of the scores in the three dimensional matrix 400. The particular period of time can be provided by a merchant that can sell the plurality of products to the plurality of customers. The particular period of time can be provided based on business considerations associated with provision of offers. Each product can be associated with a corresponding volume constraint 502. The volume constraints 502 can be provided by a merchant. An example of a volume constraint 502 for a particular product can be quantity of the particular product that can be sold, wherein the quantity can be based on inventory of the particular product available with the merchant.

From the scores in the spatial intersection 500, a first set of one or more scores can be randomly determined. The random determining of the first set of one or more scores can be performed using a pseudorandom number generation algorithm. The pseudorandom number generation algorithm can be performed by a linear congruential generator.

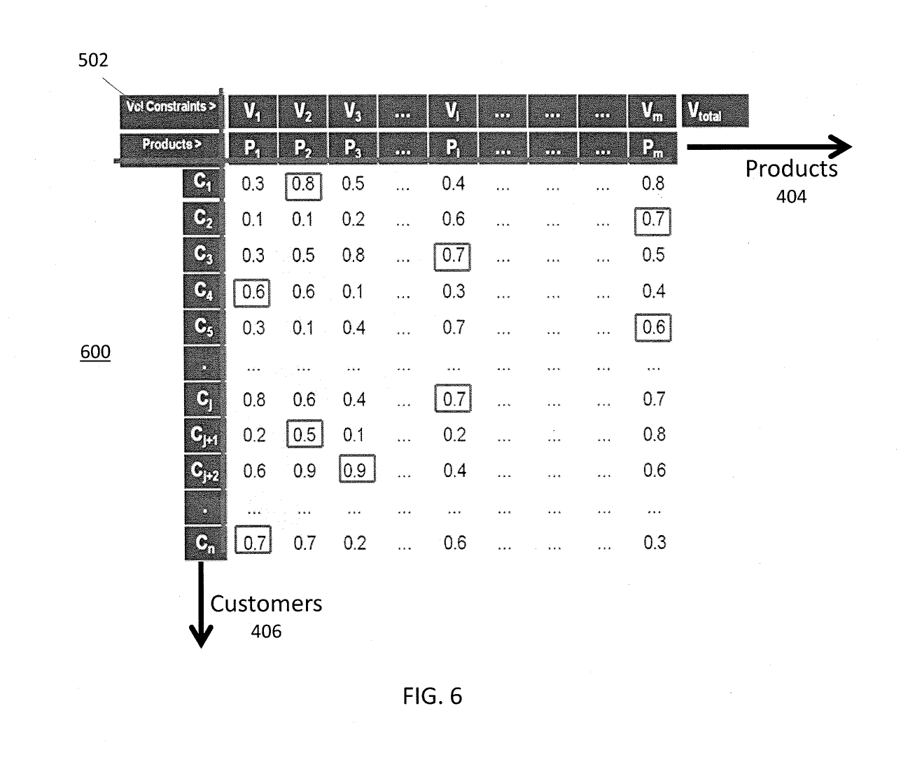

FIG. 6 illustrates a spatial intersection 600 showing, in enclosed rectangular boxes, scores corresponding to the randomly determined pairs of customers and products. The scores enclosed by the rectangular boxes can be changed to zero. Thus, the randomly determined first set of one or more scores can be changed to zero.

In some alternate implementations, from the randomly detected scores, scores can be determined that correspond to customers that receive offers on a number of products that can be more than a first threshold. The first threshold can be calculated based on the volume constraint. The dependency of the first threshold on the volume constraint can advantageously ensure that a customer can be provided offers for a number of products which is less than or equal to a number of products available with the merchant. Scores corresponding to customers receiving offers on a number of products that can be more than a first threshold can be enclosed by rectangular boxes. The scores enclosed by the rectangular boxes can be changed to zero. Thus, in these alternate implementations, a portion of the randomly determined first set of one or more scores can be changed to zero.

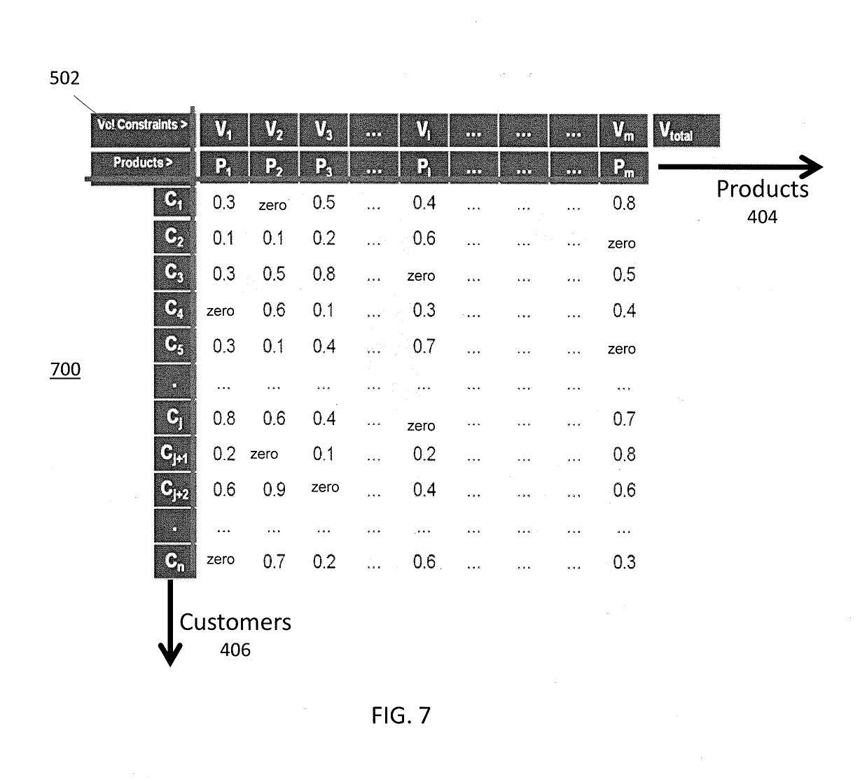

FIG. 7 illustrates a spatial intersection 700 where box-enclosed scores of spatial intersection 600 are changed to zero.

Based on scores in spatial intersection 700, the provision of offers for the plurality of products to the plurality of customers can be optimized. An optimization engine can perform the optimization based on the volumetric constraints 502. Although use of volume constraints 502 is described herein, volume constraints 502 may not be necessary for implementing the described methodologies. That is, the methodologies (for example, optimization described herein) can be implemented even when there are no volume constraints 502 or when the volume constraints 502 are unavailable/absent. The optimization engine can implement (a) optimizing algorithms that can terminate in a finite number of steps, (b) iterative methods that can converge to a solution, or (c) heuristics that can provide approximate solutions when there may not be a converged solution. The scores that have been changed to zero, and corresponding pairs of products and customers, may not participate in optimization process, as they have zero likelihood of a corresponding customer to purchase the corresponding product. The volumetric constraints 502 can be input to the optimization engine so as to determine pairs of products and customers so that customers of these pairs can be provided offers for corresponding products. Based on the optimizing, pairs of products and customers can be selected from pairs in spatial intersection 700 such that for these pairs, the corresponding customers can be provided offers (for example, best offers) on the associated products.

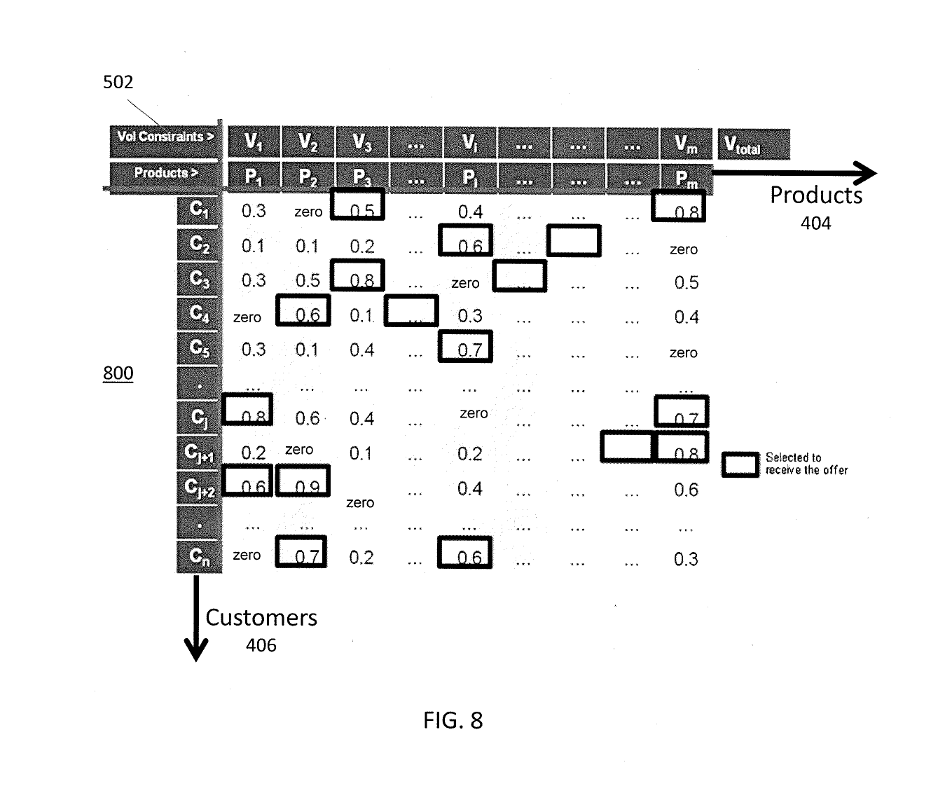

FIG. 8 illustrates a spatial intersection 800 where box-enclosed positions characterize some results of optimization, in which exclusion of offers due to zero score has taken place and alternative (for example, next/second best) offers are to be assigned. Customers corresponding to the box-enclosed scores can be provided offers on respective products.

In some implementations, a portion of scores in either spatial intersection 500 or spatial intersection 700 can be changed to one such that a customer with a one score can always be provided an offer. This determining of scores that are changed to one is described below. For each product Pᵢ (i=1 to m, where m is total number of products in either the three dimensional matrix 400 or the spatial intersection 500 or 700), a customer can be randomly selected. It can be checked that a number of products already reassigned for Cⱼ<=ceiling (z %*m). The value of z % can be provided by a merchant. Propensity score of Cⱼ and Pᵢ can be changed to one. The above-noted random selection, checking, and/or changing the score to one can be implemented for x randomly selected customers for each product, where x can be calculated according to the equation/formula: [x={f*n*(vᵢ/vₜₒₜₐₗ)}], wherein: x can be the number of customers for the corresponding product, f can be the a desired number of expected reassignments per customer, n can be a total number of customers in the spatial intersection 500 or 700 of the three dimensional matrix 400, vᵢ can be a volumetric constraint on an i^{th} product, and vₜₒₜₐₗ can be a sum of vᵢ over all products in the spatial intersection 500 or 700.

The random selecting of the customer for the corresponding product can be performed using a second pseudorandom number generation algorithm. The second pseudorandom number generation algorithm can be performed by a linear congruential generator. The second pseudorandom number generation algorithm can be the pseudorandom number generation algorithm.

The above-noted obtaining of historical purchase data, the determining of a three dimensional matrix 400, the determining/obtaining of the spatial intersection 500, changing of the one or more propensity scores to zero, the excluding of the provision of an offer when propensity score is zero, changing of other one or more propensity scores to one, and provision of offers when the propensity score is one can occur in real time.

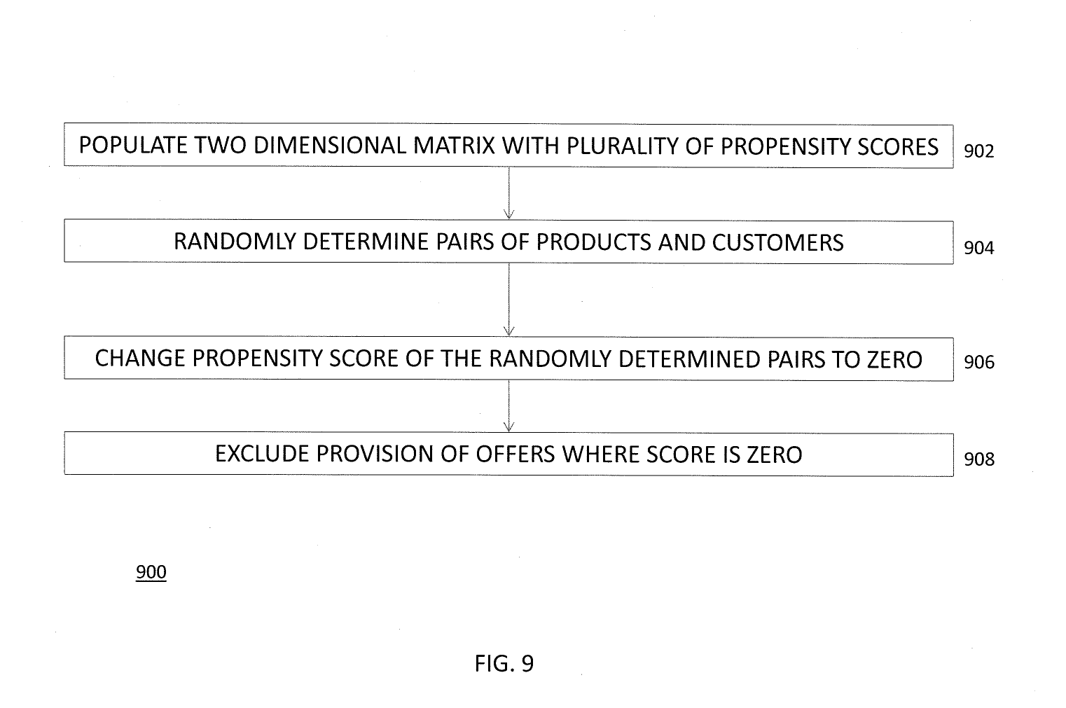

FIG. 9 is a process flow diagram 900 illustrating aspects of a method consistent with implementations of the current subject matter. A two dimensional matrix 500 can characterize a product dimension 404 and a customer dimension 406. The two dimensional matrix 500 can be populated, at 902, with a plurality of propensity scores. Each propensity score can characterize a likelihood of a corresponding customer to purchase a respective product. The two dimensional matrix 500 can be populated using a time-to-event model. One or more pairs of products and customers can be randomly determined, at 904, from the two dimensional matrix 500. Propensity scores associated with the randomly determined one or more pairs of products and customers can be changed to zero at 906. A provision of one or more offers for one or more products to corresponding one or more customers can be excluded, at 908, from optimizing (and subsequently, from provision of offers) when associated one or more propensity scores can be zero. A provision of offers to the plurality of products can be optimized such that the portion of the randomly determined first set of one or more scores that are changed to zero can be excluded from the optimizing.

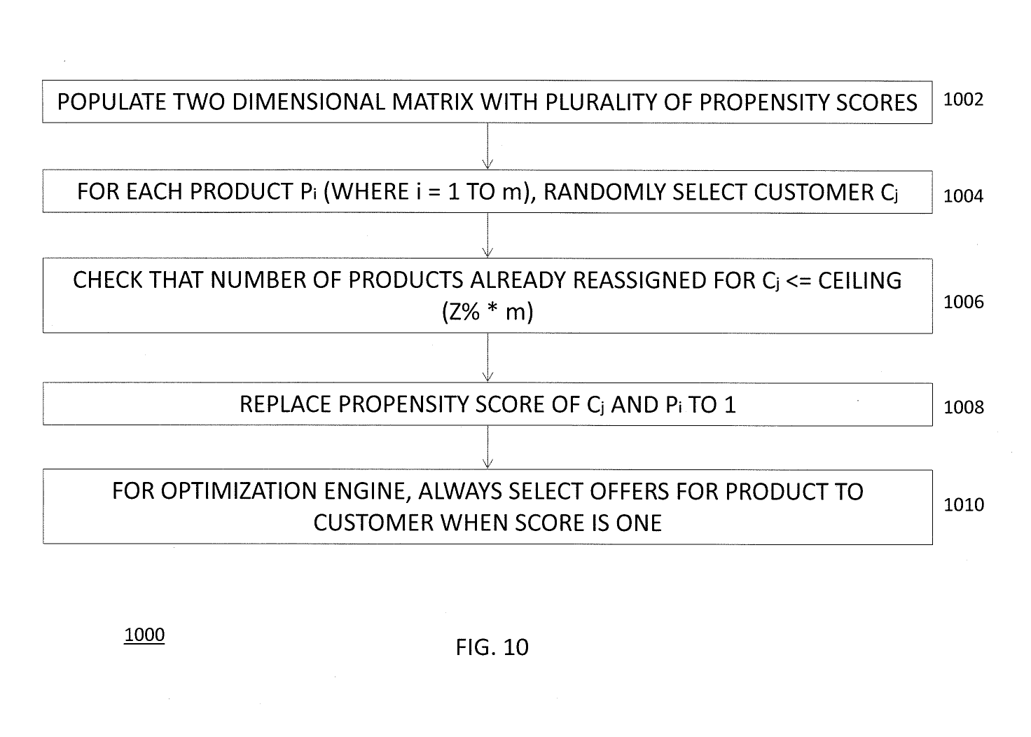

FIG. 10 is a process flow diagram 1000 illustrating aspects of a method consistent with implementations of the current subject matter. A two dimensional matrix 500 or 700 including a plurality of products and a plurality of customers can be populated, at 1002, with a plurality of propensity scores. A propensity score can characterize a likelihood of a corresponding customer to purchase a respective product. For each product Pᵢ (i=1 to m, where m is total number of products in either the three dimensional matrix 400 or the two dimensional matrix 500 or 700), a customer Cⱼ can be randomly selected, at 1004, for these some scores. It can be checked, at 1006, that a number of products already reassigned for Cⱼ can be less than or equal to ceiling value of (z %*m). The value of z % can be provided by a merchant. Propensity score of Cⱼ and Pᵢ can be changed to one at 1008. Subject matter of 1004 and 1006 can be implemented for x randomly selected customers for each product, where x can be calculated according to the equation/formula: [x={f*n*(vᵢ/vₜₒₜₐₗ)}], wherein: x can be the number of customers for the corresponding product, f can be the a desired number of expected reassignments per customer, n can be a total number of customers in the spatial intersection 500 or 700 of the three dimensional matrix 400, vᵢ can be a volumetric constraint on an i^{th} product, and vₜₒₜₐₗ can be a sum of vᵢ over all products in the two dimensional matrix 500 or 700. Optimization always selects, at 1010, offers for a product to a corresponding customer when the propensity score is one. An optimization engine performs the optimization to determine offers that are provided to the customers.

The above-described implementations associated with customers, products, and merchants are merely examples. Implementations with variables other than customers, products, and merchants are also possible. For example, in one variation, students, courses, and schools can be used instead of customers, products, and merchants, respectively. In this example, the volume constraints can be (a) a maximum number (for example, two, three, four, five, or the like) of courses allowed for a student, and (b) a maximum number of courses that can be provided by the school based on availability of teachers. A first group of students (for example, students corresponding to propensity score of zero) can be selected based on the volume constraints. The selected students in the first group can be excluded from being provided best offers (for example, interventions such as teachings by one or more teachers). This first group of students can be provided alternate offers, which can be second best offers, third best offers, fourth best offers, and so on. Subsequently, a second group of students (for example, students corresponding to propensity score of one) can be selected based on the volume constraints. The selected students in the second group can always/often be provided the best offers. Such groupings of students and provisions of corresponding offers is significantly more effective, as they are based on volumetric constraints, thereby allowing a controlled provision of offers.

Various implementations of the subject matter described herein may be realized in digital electronic circuitry, integrated circuitry, custom-designed ASICs (application specific integrated circuits), computer hardware, firmware, software, and/or combinations thereof. These various implementations may include implementation in one or more computer programs that are executable and/or interpretable on a programmable system including at least one programmable processor, which may be special/particular or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, while some of the above-noted implementations are directed to products, those implementations are also possible with services. In other implementations, combinations of products and services can be used. Further, the logic flow depicted in the accompanying figures and described herein do not require the particular order shown, or sequential order, to achieve desirable results. Other embodiments may be within the scope of the following claims.

What is claimed is:

1. A method for implementation by one or more data processors comprising:
populating, by at least one data processor, a three dimensional matrix with a first plurality of scores, each score characterizing a likelihood of a corresponding customer to purchase a respective product in an associated period of time;
randomly determining, by at least one data processor from a second plurality of scores associated with a spatial intersection of the three dimensional matrix at a particular period of time, a first set of one or more scores of the second plurality of scores;
changing, by at least one data processor, the randomly determined first set of one or more scores to zero; and
providing, by at least one data processor, one or more offers to corresponding one or more customers when associated one or more scores are more than zero.

2. The method of claim 1, further comprising:
obtaining, by at least one data processor, historical purchase data associated with a plurality of customers and a plurality of products, the first plurality of scores being generated using the historical purchase data.

3. The method of claim 2, wherein the historical purchase data comprises at least: one or more products that are purchased, one or more unique identifiers for respective one or more customers purchasing the one or more products, and one or more timestamps associated with corresponding purchases of the one or more products.

4. The method of claim 3, wherein the historical purchase data further comprises at least: one or more product web-pages that are viewed, one or more unique identifiers for respective one or more customers viewing the one or more products web-pages, and one or more timestamps associated with corresponding views of the one or more web-pages.

5. The method of claim 1, wherein the three dimensional matrix includes the first plurality of scores placed according to a customer dimension, a product dimension, and a time dimension.

6. The method of claim 1, wherein the particular period of time is provided by a merchant.

7. The method of claim 6, wherein the merchant sells the plurality of products to the plurality of customers.

8. The method of claim 1, wherein the spatial intersection of the three dimensional matrix at the particular period of time characterizes a two dimensional matrix that includes the second plurality of scores placed according to a customer dimension and a product dimension.

9. The method of claim 1, wherein the random determining of the first set of one or more scores is performed using a first pseudorandom number generation algorithm.

10. The method of claim 9, wherein the first pseudorandom number generation algorithm is performed by a linear congruential generator.

11. The method of claim 1, further comprising:
optimizing, by at least one data processor based on the second plurality of scores and the changed scores, a provision of offers for the plurality of products to the plurality of customers, the portion of the randomly determined first set of one or more scores that are changed to zero being excluded from the optimizing; and
providing, by at least one data processor based on the optimizing, alternative one or more offers for one or more products to corresponding one or more customers when associated one or more propensity scores are zero.

12. The method of claim 11, wherein:
the three dimensional matrix further comprises one or more volumetric constraints associated with one or more products, the one or more volumetric constraints being provided by a merchant, each volumetric constraint limiting a number of offers that can be provided for an associated product;
the optimizing is performed by an optimization engine; and
the volumetric constraints are input to the optimization engine so as to determine the offers for the plurality of products to the plurality of customers.

13. The method of claim 1, further comprising:
calculating, by at least one data processor for a corresponding product and based on a volumetric constraint specific for each product, a number of customers;
randomly selecting, by at least one data processor for the corresponding product and for the calculated number of times, a customer, a number of times a propensity score associated with the corresponding product and the randomly selected customer is previously reassigned being one of less than and equal to a threshold;
changing, by at least one data processor, the propensity score associated with the corresponding product and the customer to one; and
providing, by at least one data processor, an offer for the corresponding product to the randomly selected customer.

14. The method of claim 13, wherein the calculating of the number of customers for the corresponding product is based on:
x={f*n*(vᵢ/vₜₒₜₐₗ)},
wherein:
x is the number of customers for the corresponding product,
f is the a number of expected reassignments per customer,
n is a number of customers in the spatial intersection of the three dimensional matrix,
vᵢ is a volumetric constraint on an i^{th} product, and
vₜₒₜₐₗ is a sum of vᵢ over products associated with the first plurality of scores.

15. The method of claim 13, wherein the random selecting is performed using a pseudorandom number generation algorithm.

16. The method of claim 15, wherein the pseudorandom number generation algorithm is performed by a linear congruential generator.

17. The method of claim 15, wherein the pseudorandom number generation algorithm is same as a first pseudorandom number generation algorithm used to randomly determine the first set of one or more scores.

18. The method of claim 13, wherein:
the volumetric constraint is provided by a merchant; and
the threshold is a ceiling value of a particular percentage of a number of products in the spatial intersection of the three dimensional matrix.

19. The method of claim 13, wherein the providing of the offer to the randomly selected customer occurs in real time.

20. The method of claim 1, wherein:
the providing of one or more offers to corresponding one or more customers when associated one or more scores are more than zero comprises excluding other customers from being provided offers when associated score is zero;
the populating of the three dimensional matrix, the changing of the randomly determined first set of one or more scores to zero, and the excluding the providing of offers to the other customers occur in real time.

21. A method for implementation by one or more data processors comprising:
obtaining, by at least one data processor, a two dimensional matrix characterizing a product/service dimension and a customer dimension, the two dimensional matrix populated with a plurality of propensity scores, each propensity score characterizing a likelihood of a corresponding customer to purchase a respective product/service;
randomly determining, by at least one data processor, one or more positions of propensity scores in the two dimensional matrix;
changing, by at least one data processor, propensity scores associated with the randomly determined positions to zero; and
providing, by at least one data processor, one or more offers to corresponding one or more customers when associated one or more propensity scores are more than zero.

22. The method of claim 21, wherein the two dimensional matrix is obtained using a time-to-event model.

23. The method of claim 21, further comprising:
optimizing, by at least one data processor, a provision of offers for the plurality of products/services to the plurality of customers, the randomly determined first set of one or more scores that are changed to zero being excluded from the optimizing.

24. A method for implementation by one or more data processors comprising:
obtaining, by at least one data processor, a two dimensional matrix comprising a plurality of products/services and a plurality of customers, the two dimensional matrix populated with a plurality of propensity scores;
calculating, by at least one data processor for a corresponding product/service and based on a volumetric constraint specific for each product/service, a number of customers;
randomly selecting, by at least one data processor for the corresponding product/service and for the calculated number of times, a customer, a number of times a propensity score associated with the corresponding product/service and the randomly selected customer is previously reassigned being one of less than and equal to a threshold;
changing, by at least one data processor, the propensity score associated with the corresponding product/service and the customer to one; and
providing, by at least one data processor, an offer for the corresponding product/service to the randomly selected customer.

25. The method of claim 24, wherein the number of customers for the corresponding product/service is calculated based on:
x={f*n*(vᵢ/vₜₒₜₐₗ)},
wherein:
x is the number of customers for the corresponding product/service,
f is the a desired number of expected reassignments per customer,
n is a number of customers in the two dimensional matrix,
vᵢ is a volumetric constraint on an i^{th} product/service, and
vₜₒₜₐₗ is a sum of vᵢ over products/services in the two dimensional matrix.

26. The method of claim 24, wherein each propensity score characterizes a likelihood of a corresponding customer to purchase a respective product/service.
